(19) United States
(12) Patent Application Publication
(10) Pub. No.: US 2016/0342770 A1
(43) Pub. Date: Nov. 24, 2016

(54) METHOD AND SYSTEM FOR INTEGRATING INFECTIOUS DISEASE DATA WITH TRANSACTION DATA

(71) Applicant: MasterCard International Incorporated, Purchase, NY (US)

(72) Inventors: Kenneth UNSER, Fairfield, CT (US); Harrison SIEGEL, Glencoe, IL (US)

(73) Assignee: MasterCard International Incorporated, Purchase, NY (US)

(21) Appl. No.: 14/716,253

(22) Filed: May 19, 2015

(51) Int. Cl. G06F 19/00; G06Q 30/02; G06Q 40/00

(52) U.S. Cl. CPC G06F 19/3493; G06Q 40/12; G06Q 30/0201

(57) ABSTRACT

A method for tracking existence and spread of infectious diseases using transaction data includes: storing transaction data entries, each entry including data related to a payment transaction including a transaction time, geographic location, and transaction data; receiving disease data indicating an infectious disease in a geographic area, the data including an infection period of time; identifying a first subset of transaction data entries including the geographic location in the received disease data and where the transaction time is within the infection period of time; identifying a second subset of transaction data entries that include a geographic location in a shared geographic area where the included transaction data corresponds to the transaction data included in the transaction data entries in the first subset; and transmitting an infection notification, the notification including at least the shared geographic area.

### FIELD

The present disclosure relates to the linking of infectious disease data with transaction data, specifically the use of transaction data to track the spread of infectious diseases in areas and among consumers for estimation and prediction thereof.

### BACKGROUND

The spread of infectious diseases can have a number of negative effects on not only the people infected, but also by those surrounding the infected and the population as a whole, especially in instances when a disease may spread more quickly or more widely than anticipated. For example, health services may be unprepared for unexpected or unanticipated outbreak of a disease, which may lead to problems in treatment and care for the infected. In addition, lack of preparation may also lead to individuals that go undiagnosed or untreated traveling to other areas, which may further spread a disease and compound the situation. As a result, the identification of potentially infected or carrying individuals, as well as the identification of at-risk areas, may be extremely beneficial in the treatment of infectious diseases.

However, existing technical systems for analyzing and providing support for health services for the spread of infectious diseases are often reactionary rather than proactive. Current systems may be able to track the prior movements of an individual known to be infected with or a carrier of a disease, in order to identify the source of an outbreak, but are often unable to identify or predict present or future movements in order to identify the potential spread of the disease. Other systems may be configured to model the spread of a disease in one geographic location to estimate the spread of the disease in another known infected area, but may be unable to predict what area may be infected, and often rely on data that cannot be obtained in real-time.

Thus, there is a need for a technical solution to assist in the tracking and prediction of the spread of infectious diseases among individuals and areas. Current systems either operate on outdated data that may either not provide an accurate estimate of the spread of a disease or may provide estimates too late to be beneficial, or may be purely reactionary and unable to provide estimates of future behavior entirely. In addition, current systems often operate using technical data regarding the disease itself and population demographics, which may be ill suited for determining the behaviors of either an individual or population as a whole. Furthermore, these current systems are also often incapable of storing or analyzing such types of data, such as transaction data, due to the sensitive nature of such data and the specialized communication protocols and standards associated thereto. As a result, current systems may be incapable of both tracking and predicting existence and spread of infectious diseases, and of handling sensitive transaction data for use thereof.

### SUMMARY

The present disclosure provides a description of systems and methods for tracking existence and spread of infectious diseases based on transaction data.

A method for tracking existence and spread of infectious diseases based on transaction data includes: storing, in a transaction database, a plurality of transaction data entries, wherein each transaction data entry includes data related to a payment transaction including at least a transaction time and/or date, a geographic location, and transaction data; receiving, by a receiving device, disease data indicating the existence of an infectious disease in a geographic area, the disease data including at least the geographic area and an infection period of time; identifying, by a processing device, a first subset of transaction data entries stored in the transaction database where the included geographic location is included in the geographic area included in the received disease data and where the included transaction time and/or date is within the infection period of time included in the received disease data; identifying, by the processing device, a second subset of transaction data entries stored in the transaction database that include a geographic location in a shared geographic area where the included transaction data corresponds to the transaction data included in the transaction data entries in the first subset of transaction data entries; and transmitting, by a transmitting device, an infection notification, wherein the infection notification includes at least the shared geographic area.

A method for identifying existence and spread of an infectious disease based on transaction data includes: storing, in a transaction database, a plurality of transaction data entries, wherein each transaction data entry includes data related to a payment transaction including at least a consumer identifier associated with a consumer involved in the related payment transaction and a transaction time and/or date; receiving, by a receiving device, disease data indicating a consumer associated with an infectious disease including at least a specific consumer identifier associated with the indicated consumer and an infection period of time; identifying, by a processing device, a subset of transaction data entries stored in the transaction database where the included consumer identifier corresponds to the specific consumer identifier included in the received disease data and where the included transaction time and/or date is within the infection period of time included in the received disease data; identifying, by the processing device, at least one notification transaction data entry stored in the transaction database where the included transaction time and/or date and the transaction data corresponds to the transaction time and/or date and transaction data included in at least one transaction data entry in the subset; and transmitting, by a transmitting device, an infection notification, wherein the infection notification includes at least one of: the consumer identifier and a portion of the transaction data included in the identified at least one notification transaction data entry.

A system for tracking existence and spread of infectious diseases based on transaction data includes a transaction database, a receiving device, a processing device, and a transmitting device. The transaction database is configured to store a plurality of transaction data entries, wherein each transaction data entry includes data related to a payment transaction including at least a transaction time and/or date, a geographic location, and transaction data. The receiving device is configured to receive disease data indicating the existence of an infectious disease in a geographic area, the disease data including at least the geographic area and an infection period of time. The processing device is configured to: identify a first subset of transaction data entries stored in the transaction database where the included geographic location is included in the geographic area included in the received disease data and where the included transaction time and/or date is within the infection period of time included in the received disease data; and identify a second subset of transaction data entries stored in the transaction database that include a geographic location in a shared geographic area where the included transaction data corresponds to the transaction data included in the transaction data entries in the first subset of transaction data entries. The transmitting device is configured to transmit an infection notification, wherein the infection notification includes at least the shared geographic area.

A system for identifying existence and spread of an infectious disease based on transaction data includes a transaction database, a receiving device, a processing device, and a transmitting device. The transaction database is configured to store a plurality of transaction data entries, wherein each transaction data entry includes data related to a payment transaction including at least a consumer identifier associated with a consumer involved in the related payment transaction and a transaction time and/or date. The receiving device is configured to receive disease data indicating a consumer associated with an infectious disease including at least a specific consumer identifier associated with the indicated consumer and an infection period of time. The processing device is configured to: identify a subset of transaction data entries stored in the transaction database where the included consumer identifier corresponds to the specific consumer identifier included in the received disease data and where the included transaction time and/or date is within the infection period of time included in the received disease data; and identify at least one notification transaction data entry stored in the transaction database where the included transaction time and/or date and the transaction data corresponds to the transaction time and/or date and transaction data included in at least one transaction data entry in the subset. The transmitting device is configured to transmit an infection notification, wherein the infection notification includes at least one of: the consumer identifier and a portion of the transaction data included in the identified at least one notification transaction data entry.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for tracking and predicting existence and spread of infectious diseases based on transaction data in accordance with exemplary embodiments.

FIG. 2 is a block diagram illustrating the processing server of FIG. 1 for tracking and predicting the existence and spread of infectious diseases based on transaction data in accordance with exemplary embodiments.

FIG. 3 is a flow diagram illustrating a process for tracking and predicting the spread of infectious diseases across geographic areas in accordance with exemplary embodiments.

FIG. 4 is a flow diagram illustrating a process for predicting the spread of infectious diseases to geographic areas and individuals in accordance with exemplary embodiments.

FIGS. 5 and 6 are flow charts illustrating exemplary methods for tracking existence and spread of infectious diseases based on transaction data in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Tracking and Predicting Existence and Spread of Infectious Diseases

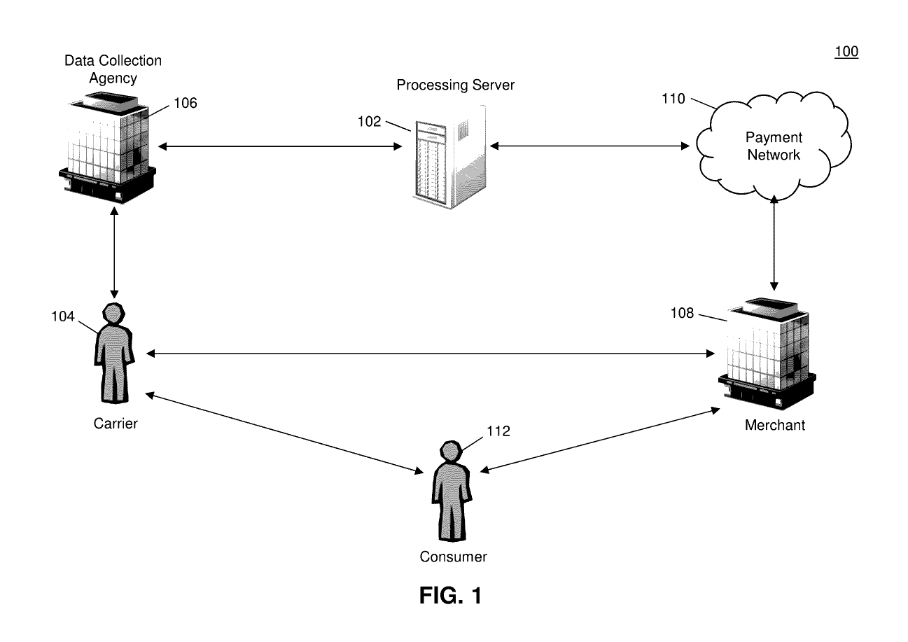

FIG. 1 illustrates a system 100 for the tracking and predicting of the existence and spread of infectious diseases based on transaction data.

The system 100 may include a processing server 102. The processing server 102, discussed in more detail below, may be configured to track and predict the existence and spread of infectious diseases across individuals and geographic areas based on transaction data using the methods and systems discussed herein. In the system 100, a carrier 104 may carry, be infected with, or otherwise be associated with an infectious disease. The carrier 104 may be identified by a data collection agency 106. The data collection agency 106 may be any suitable entity configured to collect data regarding individuals associated with infectious diseases, such as a hospital, medical office, medical facility, disease control agency, law enforcement agency, etc. The data collection agency 106 may provide a consumer identifier associated with the carrier 104 to the processing server 102.

The consumer identifier may be a value suitable for use in identifying the carrier 104, such as an account identifier, a set of demographic characteristics, a username, an e-mail address, a phone number, a street address, or other suitable value that will be apparent to persons having skill in the relevant art. The processing server 102 may then be configured to identify transaction data associated with the carrier 104. In some instances, the consumer identifier provided by the data collection agency 106 may not be unique to the carrier 104, such as a set of demographic characteristics that may match the carrier 104 and additional individuals. In such an instance, the identified transaction data may be associated with the carrier 104 or another, demographically similar individual. In other instances, the consumer identifier may be anonymized such that the processing server 102 may identify the transaction data without personally identifying the carrier 104. In such examples, the processing server 102 may identify transaction data associated with the carrier 104 without personally identifying the carrier 104, in order to protect the privacy and security of the carrier 104 and his or her transaction data.

The transaction data associated with the carrier 104 may include data associated with a plurality of payment transactions involving the carrier 104. The carrier 104 may conduct payment transactions with a plurality of merchants 108. The payment transactions may be processed by a payment network 110. The payment network 110 may provide transaction data for the payment transactions to the processing server 102. The payment transactions may be stored by the processing server 102 for identification and associated with the carrier 104, based on the consumer identifier received from the data collection agency 106. The processing server 102 may be specially configured in order to receive and store sensitive transaction data, which may include the use of special communication protocols and standards, such as the ISO 8583 standard governing the formatting and transmission of transaction messages, and the use of special data storage techniques that may be unavailable to generic computer systems. In some embodiments, the processing server 102 may be a part of the payment network 110.

In the system 100, one or more consumers 112 may also conduct payment transactions with merchants 108, which may be processed by the payment network 110. The transaction data for payment transactions involving consumers 112 may also be provided to the processing server 102. The processing server 102 may, using the transaction data for the known carrier 104, as well as the transaction data for the consumers 112, track and predict the spread and existence of infectious diseases across other individuals and geographic areas using the methods and systems discussed herein.

For example, the processing server 102 may identify the transaction data for payment transactions involving the carrier 104 before and/or during a time of infection with an infectious disease. The processing server 102 may then identify transaction data that includes similar behavior in the transaction data provided by the payment network 110. Consumers 112 that are associated with the transaction data may then be identified as potentially being infected with the infectious disease, based on the similarity in transaction behavior with the known carrier 104. In some instances, the consumers 112 or health services may be notified, to provide assistance to the consumers 112. In other instances, health services may be notified of potential outbreaks and/or spreading of the infectious disease based on geographic locations of the consumers 112 (e.g., based on the transaction data or other suitable methods for identifying the geographic location of a consumer 112 that will be apparent to persons having skilled in the relevant art).

In another example, the processing server 102 may identify geographic areas that may have potential for becoming infected with the infectious disease based on the transaction data for the carrier 104. For example, the data collection agency 106 may provide a time of infection or period of infection for the carrier 104. The processing server 102 may then identify geographic locations of payment transactions for the carrier 104 during and/or after the time or period of infection, to identify where the carrier 104 traveled. In addition, the processing server 102 may analyze transaction data for the carrier 104 prior to the time or period of infection to predict future movement of the carrier 104, using methods and systems that will be apparent to persons having skill in the relevant art. The processing server 102 may analyze the predicted future movement to determine potential spreading of infection in new geographic areas, such as based on the type of transactions. For instance, the potential may be low for transactions involving minimal human contact (e.g., drive-thru at a fast food restaurant) and may be higher for transactions involving significant human contact (e.g., working out at a gym). In some instances, potential spreading may also be based on the infectious disease and associated properties, and additional criteria.

In some embodiments, the processing server 102 may be able to track and predict existence and spread of infectious diseases across geographic areas based on transaction data. For example, the data collection agency 106 may provide data to the processing server 102 regarding the existence of an infectious disease in a geographic area. The processing server 102 may then identify transaction data for payment transactions in the geographic area. The processing server 102 may identify transaction data for other geographic areas that may be similar to the transaction data for the payment transactions in the known infected area, to identify the other geographic areas as potentially infected or at-risk of infection. In some instances, the data collection agency 106 may provide a time of or period of infection. In such an instance, the processing server 102 may analyze the transaction data before the time or period of infection and compare the analysis to analysis of transaction data in other geographic areas, to predict which areas will become or have started to become infected. By predicting the spread of the infectious disease at such an early stage based on transaction data, health services and appropriate agencies may be notified, such as to prepare for increased treatment of the disease, procurement of additional medicine and facilities, etc.

By using transaction data to track and predict the existence and spread of infectious diseases, the processing server 102 may be able to identify potentially infected consumers 112 and geographic areas prior to infection, or at an early stage of infection that may be otherwise unidentifiable. Identification at such an early stage may result in better preparation and treatment, which can lead to increased success in treating the infectious disease, not only because of the early identification, but also because increased preparation may lead to the increased availability of necessary services and medicine. Furthermore, because transaction data may be available from periods both before and after infection, the processing server 102 may provide for more detailed analysis and prediction regarding the behaviors of infected areas and individuals, which may provide for an even stronger prediction of the spread and infection of a disease. As a result, the methods and systems discussed herein may use transaction data, which is unavailable to, and often unobtainable by, existing systems to track the existence and spread of infectious diseases more quickly and accurately, and to also provide predictive analysis of the spread of infectious diseases at both the individual and aggregate level that is unavailable in existing systems.

### Processing Server

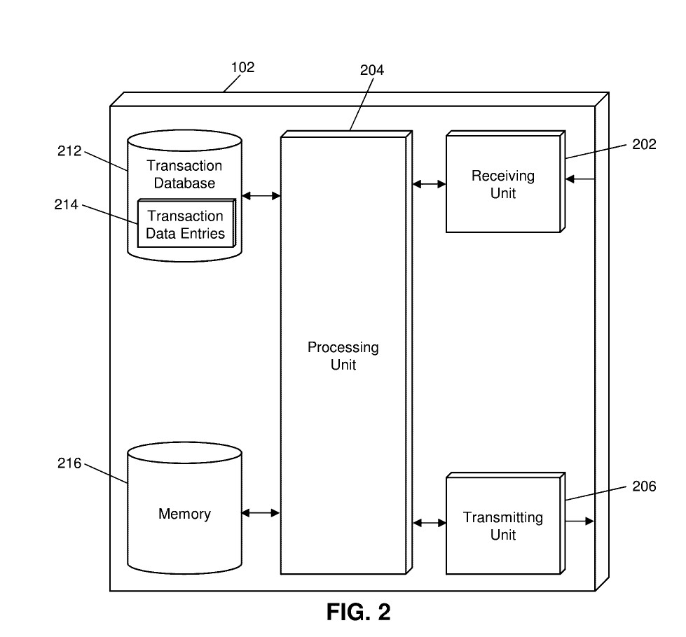

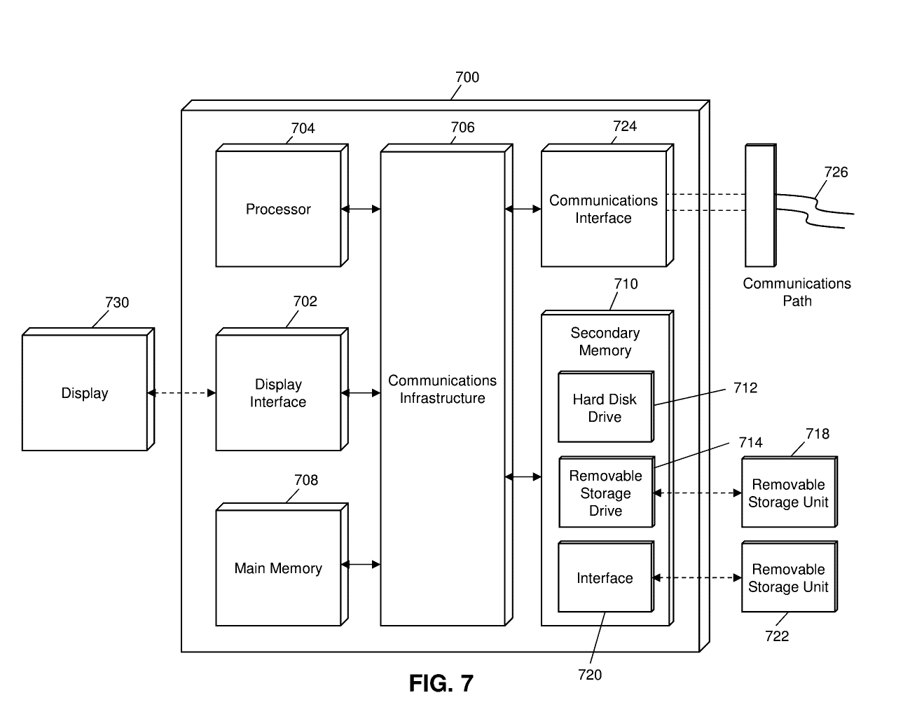

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive data from the collection agency 106 regarding infectious diseases, such as disease data regarding carriers 104 or geographic areas. The disease data may include consumer identifier associated with carriers 104, disease characteristics, disease names, disease types, times of infection, periods of infection, geographic locations, etc. The receiving unit 202 may also receive transaction data, such as from the payment network 110, merchants 108, or other suitable entities. In some embodiments, the transaction data may be received using payment rails and using specially configured transaction messages, such as those formatted pursuant to the ISO 8583 standard.

The processing server 102 may also include a transaction database 212. The transaction database 212 may be configured to store a plurality of transaction data entries 214. Each transaction data entry 214 may include data related to a payment transaction and may be configured to store transaction data for the related payment transaction as received by the receiving unit 202. The transaction data may include at least geographic location, a transaction time and/or date, and additional transaction data. In some embodiments, the transaction data may also include a consumer identifier associated with a consumer involved in the related payment transaction. The additional transaction data may include a transaction amount, product data, merchant data, reward data, loyalty data, offer data, point of sale data, etc.

The processing server 102 may further include a processing unit 204. The processing unit 204 may be configured to perform the functions of the processing server 102 discussed herein as will be apparent to persons having skill in the relevant art. The processing unit 204 may be configured to identify transaction data entries 214 associated with disease data received by the receiving unit 202. For example, if the disease data includes a consumer identifier associated with a carrier 104 of an infectious disease, the processing unit 204 may identify transaction data entries 214 including the consumer identifier. In another example, if the disease data includes a geographic area associated with an infectious disease, the processing unit 204 may identify transaction data entries 214 with geographic locations included in the geographic area. In embodiments where a carrier 104 is identified with demographic characteristics, the processing unit 204 may identify transaction data entries 214 associated with the identified demographic characteristics.

The processing unit 204 may also be configured to perform analysis of the transaction data included in transaction data entries 214. For example, the processing unit 204 may identify a plurality of purchase behaviors for a set of transaction data entries 214, such as those identified in response to received disease data. Purchase behaviors may include propensities to purchase for a plurality of criteria, such as to purchase specific products, purchase at specific merchants, spend specific amounts or ranges of amounts, purchase specific manufacturers, purchase types of products, purchase at types of merchants, purchase at a specific time or during a specific period of time, etc., or a combination thereof. In some instances, the processing unit 204 may identify multiple sets of purchase behaviors for a set of transaction data entries 214, such as corresponding to a time before infection, a period of infection, and a period after infection for a carrier 104 or geographic area.

The processing unit 204 may also be configured to identify correspondences between purchase behaviors for sets of transaction data entries 214, and to perform analysis and/or predictions based thereon. For example, the processing unit 204 may identify purchase behaviors for a set of transaction data entries 214 for a geographic area that correspond to the purchase behaviors for a set of transaction data entries 214 for activity prior to infection of a known geographic area. The processing unit 204 may then identify the geographic area as at-risk for infection with the infectious disease due to the similarity in transaction behavior for the area. In some instances, the processing unit 204 may also be configured to estimate a time of infection for a consumer 112 or geographic area based on correspondences to the transaction data identified based on the disease data and an included time of infection.

In some embodiments, the processing unit 204 may also be configured to identify geographic areas and/or consumers 112 that may be at-risk based on geographic locations in transaction data for payment transactions for a known carrier 104, such as based on a time and/or period of infection included in the received disease data. In such embodiments, the processing unit 204 may also be configured to predict movement of a carrier 104 based on the geographic locations of their past transaction data using methods and systems that will be apparent to persons having skill in the relevant art.

The processing server 102 may also include a transmitting unit 206. The transmitting unit 206 may be configured to transmit data over one or more networks via one or more network protocols. For example, the transmitting unit 206 may be configured to transmit geographic area and/or consumer 112 data, such as to the data collection agency 106, to consumers 112, to health services, to a municipal agency, etc. regarding the existence or spread of an infection disease. In another example, the transmitting unit 206 may transmit travel predictions for a carrier 104, information identifying geographic areas visited by the carrier 104 or likely to be visited by the carrier 104, information identifying consumers 112 in contact with the carrier 104 (e.g., based on transaction time and geographic location), etc. The transmitting unit 206 may also be configured to transmit data to additional entities, such as requests for transaction data to the payment network 110 using suitable protocols and formats, or data to a display device interfaced with the processing server 102 for display of data identified by the processing unit 204.

The processing server 102 may also include a memory 216. The memory 216 may be configured to store data suitable for performing the functions of the processing server 102 as discussed herein. For example, the memory 216 may be configured to store rules and/or algorithms for identifying purchase behaviors, analyzing transaction data, identifying correspondences in transaction data sets and purchase behaviors, predicting future travel for carriers 104, estimating times of infection, etc. Additional data that may be stored in the memory 216 will be apparent to persons having skill in the relevant art.

### Process for Tracking Infectious Diseases Across Geographic Areas

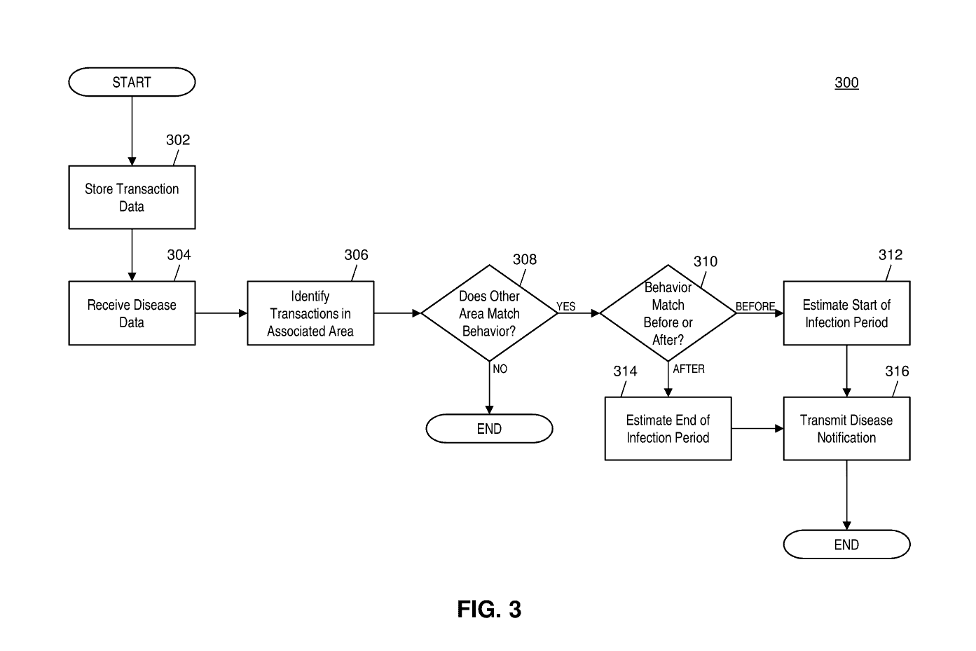

FIG. 3 illustrates a process 300 for the tracking and predicting of existence and spread of infectious diseases across geographic areas based on transaction data using the processing server 102 illustrated in FIG. 2.

In step 302, the processing unit 204 of the processing server 102 may store transaction data in the transaction database 212, as the plurality of transaction data entries 214. Each transaction data entry 214 may store data related to a payment transaction including at least a transaction time and/or date, a geographic location, and transaction data. In step 304, the receiving unit 202 of the processing server 102 may receive disease data, such as from the data collection agency 106. The disease data may indicate the existence of an infectious disease in a geographic area and include at least the geographic area and an infection period of time.

In step 306, the processing unit 204 may identify transaction data entries 214 that include geographic locations within the geographic area included in the disease data. In some embodiments, the transaction time and/or date included in each transaction data entry 214 may also be included in the infection period of time. In step 308, the processing unit 204 may identify if transaction behavior based on the transaction data included in transaction data entries 214 having geographic locations for any other geographic area match the transaction behavior for the identified set of transaction data entries 214. If there is no matching area, then the process 300 may be completed as it may indicate no spread of the infectious disease.

If there is a matching area, then in step 310, the processing unit 204 may determine if the match in transaction behavior is before the infection period of time or after the infection period of time. If the match is for behavior before the infection period of time, then, in step 312, the processing unit 204 may estimate a start time for the infection period for the other area. The start time may be based on the match between the transaction behavior for the two areas and the actual infection period of time. For example, if the present transaction data for the other area matches the transaction data for the infected area five days before the infection time, then the processing unit 204 may estimate that the infection will hit the other area in five more days. In some embodiments, step 312 may include estimating the length of time for the infection based on the transaction behavior and/or the infection period of time.

If the match in transaction behavior is for after the infection period of time (e.g., or at least from a start of the infection period of time), then, in step 314, the processing unit 204 may estimate an end time for the infection for the other area. The end time may be based on the match between the transaction behavior for the two areas, the start of the infection for the other area (e.g., estimated by the processing unit 204 based on the transaction data), and the infection period of time. For example, if the transaction data for the other area indicates infection was one week prior, and the infection period of time included in the disease data was three weeks, the processing unit 204 may estimate that the infection will be over for the other area in two more weeks.

Once the estimates have been performed, then, in step 316, the transmitting unit 206 of the processing server 102 may transmit the estimates, such as to one or more medical services, governmental agencies, etc.

### Process for Tracking Infectious Diseases Based on Individual Transaction Data

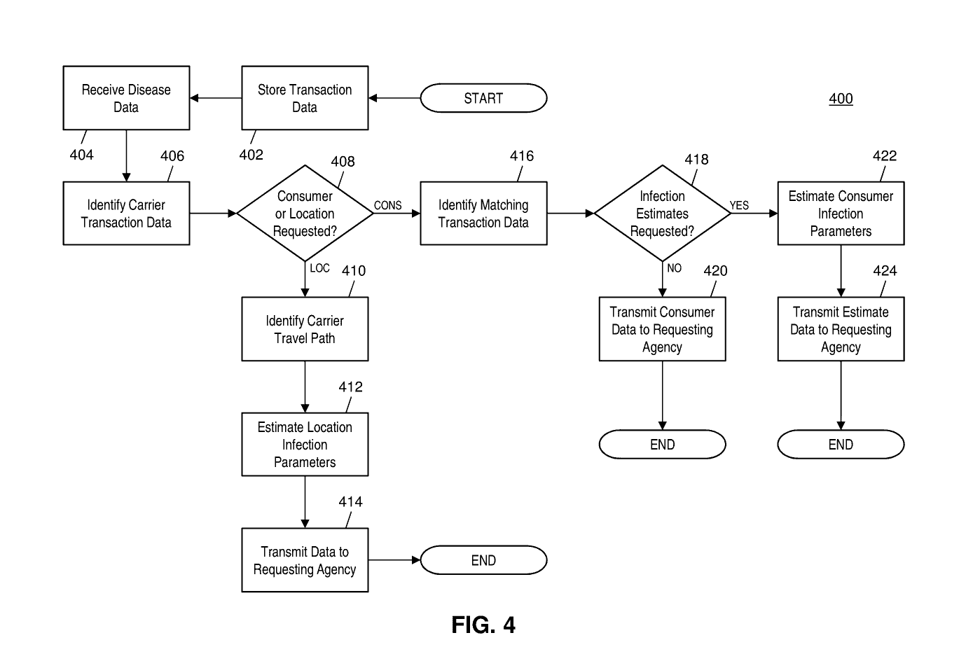

FIG. 4 illustrates a process 400 for the prediction and tracking of existence and spread of an infectious disease to geographic areas and/or consumers 112 based on transaction data for a known carrier 104 by the processing server 102.

In step 402, the processing unit 204 of the processing server 102 may store transaction data for a plurality of payment transaction as transaction data entries 214 in the transaction database 212. Each transaction data entry 214 may include data related to a payment transaction including at least a consumer identifier associated with a consumer 112 and/or carrier 104 involved in the related payment transaction and a transaction time and/or date. In step 404, the receiving unit 202 of the processing server 102 may receive disease data, such as from the data collection agency 106. The disease data may indicate a carrier 104 associated with an infectious disease and include at least a specific consumer identifier associated with the carrier 104 and an infection period of time.

In step 406, the processing unit 204 may identify a set of transaction data entries 214 in the transaction database 212 that include the specific consumer identifier associated with the carrier 104. In some embodiments, the transaction data entries 214 in the set may include a transaction time and/or date included in the infection period of time. In some instances, the processing unit 204 may identify a set of transaction data entries 214 for before, during, and after the infection period of time. In step 408, the processing unit 204 may determine if a consumer or location identification is requested. The determination may be made based on data received by the receiving unit 202, such as from a requesting entity, an input device, etc.

If a location identification is requested, then, in step 410, the processing unit 204 may determine a travel path of the carrier 104 based on the transaction data. The travel path may include geographic locations visited after a time of infection, and may also include predicted future travel locations based on transaction data during and before the infection period of time. In step 412, the processing unit 204 may estimate infection parameters for each geographic location in the identified travel path. Infection parameters may include estimated time of visit by the carrier 104, likelihood of infection spread (e.g., based on disease parameters, type of payment transaction, length of visit, etc.), and other parameters that will be apparent to persons having skill in the relevant art. In step 414, the transmitting unit 206 of the processing server 102 may transmit the estimated location infection parameters, such as to the requesting entity.

If, in step 408, a consumer identification is requested, then, in step 416, the processing unit 204 may identify transaction behavior for another set of transaction data entries 214 that includes a common consumer identifier that matches the transaction behavior for the set of transaction data entries 214 identified for the carrier 104. In step 418, the processing unit 204 may determine if an estimate of the infectious disease is requested. If no estimate is requested, then, in step 420, the transmitting unit 206 may transmit data regarding the consumer 112 to the requesting entity or agency. The data may include identification data, such as the consumer identifier and/or demographic data, or other suitable data, such as geographic location data, etc.

If, in step 418, the processing unit 204 determines that infection estimates are requested, then, in step 422, the processing unit 204 may estimate infection parameters for the consumer 112 associated with the common consumer identifier in the matched set of transaction data entries 214. The infection parameters may be estimated based on the matches in transaction behavior in the sets of transaction data entries 214 and the data included therein, and may include estimated time of infection, estimated length of infection, estimated end of infection, strength of infection, likelihood of spread of infection, etc. For example, if the present transaction behavior for the consumer 112 matches the transaction behavior for the carrier 104 three days before exhibiting signs of infection, then the consumer 112 may be estimated to exhibit signs of infection in three days. In step 424, the transmitting unit 206 may transmit the estimate data, and any additional consumer information requested, to the requesting agency. The requesting agency may then act accordingly, such as by notifying the consumer 112, providing necessary healthcare services, etc.

### First Exemplary Method for Identifying Existence and Spread of Infectious Diseases

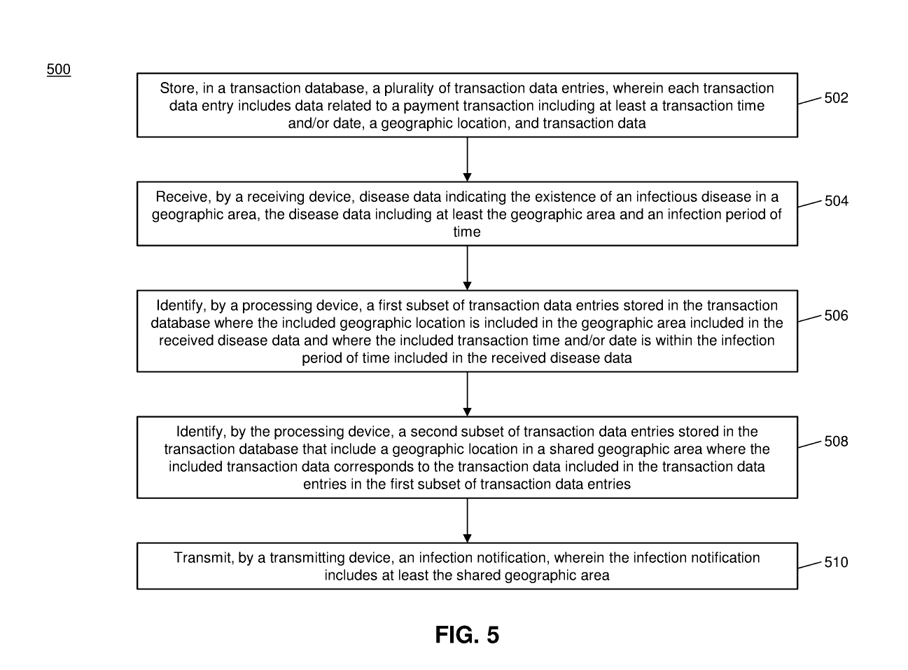

FIG. 5 illustrates a method 500 for identifying the existence and spread of infectious diseases based on transaction data for a geographic area.

In step 502, a plurality of transaction data entries (e.g., transaction data entries 214) may be stored in a transaction database (e.g., the transaction database 212), wherein each transaction data entry 214 includes data related to a payment transaction including at least a transaction time and/or date, a geographic location, and transaction data. In some embodiments, the transaction data may include at least one of: merchant data and product data. In step 504, disease data indicating the existence of an infectious disease in a geographic area may be received by a receiving device (e.g., the receiving unit 202), the disease data including at least the geographic area and an infection period of time. In one embodiment, the infection period of time may correspond to a period of time prior to identification of the infectious disease in the geographic area.

In step 506, a first subset of transaction data entries 214 stored in the transaction database 212 may be identified by a processing device (e.g., the processing unit 204) where the included geographic location is included in the geographic area included in the received disease data and where the included transaction time and/or date is within the infection period of time included in the received disease data. In step 508, a second subset of transaction data entries 214 stored in the transaction database 212 may be identified by the processing device 204 that include a geographic location in a shared geographic area where the included transaction data corresponds to the transaction data included in the transaction data entries 214 in the first subset of transaction data entries.

In step 510, an infection notification may be transmitted by a transmitting device (e.g., the transmitting unit 206), wherein the infection notification includes at least the shared geographic area. In some embodiments, the method 500 may further include estimating, by the processing device 204, a period of infection for the shared geographic area based on the correspondence between the transaction data included in the transaction data entries 214 in the second subset to the transaction data included in the transaction data entries 214 in the first subset, wherein the infection notification further includes the estimated period of infection.

### Second Exemplary Method for Identifying Existence and Spread of Infectious Diseases

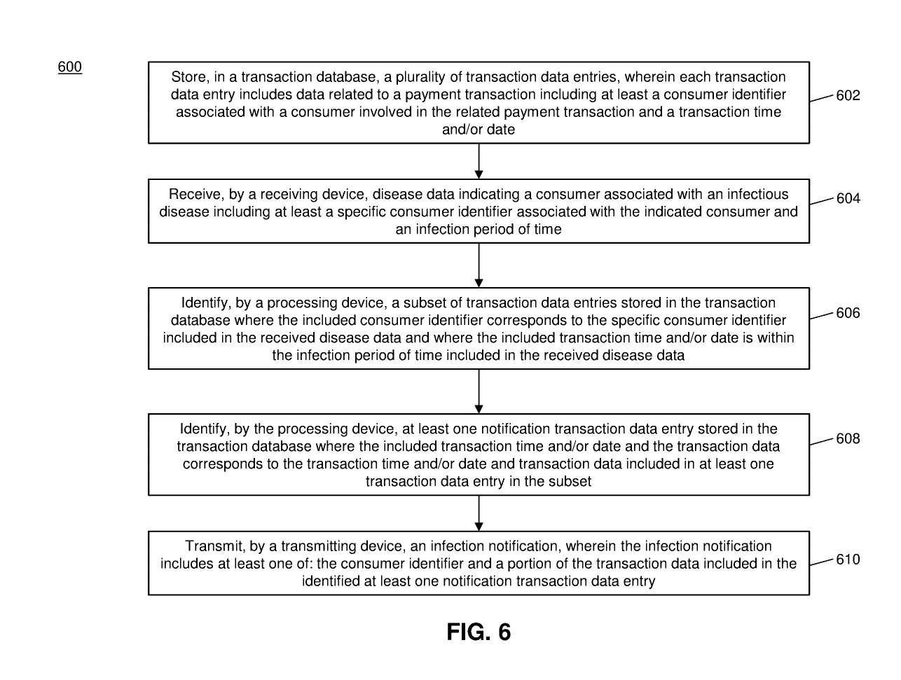

FIG. 6 illustrates a method 600 for identifying the existence and spread of infectious diseases based on transaction data for an individual associated with the infectious disease.

In step 602, a plurality of transaction data entries (e.g., transaction data entries 214) may be stored in a transaction database (e.g., the transaction database 212), wherein each transaction data entry 214 includes data related to a payment transaction including at least a consumer identifier associated with a consumer involved in the related payment transaction and a transaction time and/or date. In some embodiments, the transaction data may further include a geographic location. In step 604, disease data indicating a consumer (e.g., the carrier 104) associated with an infectious disease may be received by a receiving device (e.g., the receiving unit 202) including at least a specific consumer identifier associated with the indicated consumer 104 and an infection period of time. In some embodiments, the infection period of time may correspond to a period of time prior to identification of the infectious disease as being associated with the indicated consumer 104.

In step 606, a subset of transaction data entries 214 stored in the transaction database 212 may be identified by a processing device (e.g., the processing unit 204) where the included consumer identifier corresponds to the specific consumer identifier included in the received disease data and where the included transaction time and/or date is within the infection period of time included in the received disease data. In step 608, at least one notification transaction data entry 214 stored in the transaction database 212 may be identified by the processing device 204 where the included transaction time and/or date and the transaction data corresponds to the transaction time and/or date and transaction data included in at least one transaction data entry 214 in the subset. In step 610, an infection notification may be transmitted by a transmitting device (e.g., the transmitting unit 206), wherein the infection notification includes at least one of: the consumer identifier and a portion of the transaction data included in the identified at least one notification transaction data entry 214.

In one embodiment, the method 600 may further include estimating, by the processing device 204, a time of infection based on the correspondence between the transaction time and/or date and transaction data included in the at least one notification transaction data entry 214 to the transaction time and/or date and transaction data included in the at least one transaction data entry in the subset, wherein the infection notification further includes the estimated time of infection. In a further embodiment, the time of infection may be associated with a consumer (e.g., the consumer 112) associated with the consumer identifier included in the identified at least one notification transaction data entry 214. In another further embodiment, each transaction data entry 214 may further include a geographic location, and the time of infection may be associated with a geographic area that includes the geographic location included in each of the at least one notification transaction data entry 214.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for tracking existence and spread of infectious diseases based on transaction data, identifying high risk merchants, identifying violative emails using aliasing, and automatically submitting alias email addresses. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for tracking existence and spread of infectious diseases based on transaction data, comprising:
storing, in a transaction database, a plurality of transaction data entries, wherein each transaction data entry includes data related to a payment transaction including at least a transaction time and/or date, a geographic location, and transaction data;
receiving, by a receiving device, disease data indicating the existence of an infectious disease in a geographic area, the disease data including at least the geographic area and an infection period of time;
identifying, by a processing device, a first subset of transaction data entries stored in the transaction database where the included geographic location is included in the geographic area included in the received disease data and where the included transaction time and/or date is within the infection period of time included in the received disease data;
identifying, by the processing device, a second subset of transaction data entries stored in the transaction database that include a geographic location in a shared geographic area where the included transaction data corresponds to the transaction data included in the transaction data entries in the first subset of transaction data entries; and
transmitting, by a transmitting device, an infection notification, wherein the infection notification includes at least the shared geographic area.

2. The method of claim 1, wherein the transaction data includes at least one of: merchant data and product data.

3. The method of claim 1, further comprising:
estimating, by the processing device, a period of infection for the shared geographic area based on the correspondence between the transaction data included in the transaction data entries in the second subset to the transaction data included in the transaction data entries in the first subset, wherein
the infection notification further includes the estimated period of infection.

4. The method of claim 1, wherein the infection period of time corresponds to a period of time prior to identification of the infectious disease in the geographic area.

5. A method for identifying existence and spread of an infectious disease based on transaction data, comprising:
storing, in a transaction database, a plurality of transaction data entries, wherein each transaction data entry includes data related to a payment transaction including at least a consumer identifier associated with a consumer involved in the related payment transaction and a transaction time and/or date;
receiving, by a receiving device, disease data indicating a consumer associated with an infectious disease including at least a specific consumer identifier associated with the indicated consumer and an infection period of time;
identifying, by a processing device, a subset of transaction data entries stored in the transaction database where the included consumer identifier corresponds to the specific consumer identifier included in the received disease data and where the included transaction time and/or date is within the infection period of time included in the received disease data;
identifying, by the processing device, at least one notification transaction data entry stored in the transaction database where the included transaction time and/or date and the transaction data corresponds to the transaction time and/or date and transaction data included in at least one transaction data entry in the subset; and
transmitting, by a transmitting device, an infection notification, wherein the infection notification includes at least one of: the consumer identifier and a portion of the transaction data included in the identified at least one notification transaction data entry.

6. The method of claim 5, wherein the transaction data includes a geographic location.

7. The method of claim 5, wherein the infection period of time corresponds to a period of time prior to identification of the infectious disease as being associated with the indicated consumer.

8. The method of claim 5, further comprising:
estimating, by the processing device, a time of infection based on the correspondence between the transaction time and/or date and transaction data included in the at least one notification transaction data entry to the transaction time and/or date and transaction data included in the at least one transaction data entry in the subset, wherein
the infection notification further includes the estimated time of infection.

9. The method of claim 8, wherein the time of infection is associated with a consumer associated with the consumer identifier included in the identified at least one notification transaction data entry.

10. The method of claim 8, wherein
each transaction data entry further includes a geographic location, and
the time of infection is associated with a geographic area that includes the geographic location included in each of the at least one notification transaction data entry.

11. A system for tracking existence and spread of infectious diseases based on transaction data, comprising:
a transaction database configured to store a plurality of transaction data entries, wherein each transaction data entry includes data related to a payment transaction including at least a transaction time and/or date, a geographic location, and transaction data;
a receiving device configured to receive disease data indicating the existence of an infectious disease in a geographic area, the disease data including at least the geographic area and an infection period of time;
a processing device configured to
identify a first subset of transaction data entries stored in the transaction database where the included geographic location is included in the geographic area included in the received disease data and where the included transaction time and/or date is within the infection period of time included in the received disease data, and
identify a second subset of transaction data entries stored in the transaction database that include a geographic location in a shared geographic area where the included transaction data corresponds to the transaction data included in the transaction data entries in the first subset of transaction data entries; and
a transmitting device configured to transmit an infection notification, wherein the infection notification includes at least the shared geographic area.

12. The system of claim 11, wherein the transaction data includes at least one of: merchant data and product data.

13. The system of claim 11, wherein
the processing device is further configured to estimate a period of infection for the shared geographic area based on the correspondence between the transaction data included in the transaction data entries in the second subset to the transaction data included in the transaction data entries in the first subset, and
the infection notification further includes the estimated period of infection.

14. The system of claim 11, wherein the infection period of time corresponds to a period of time prior to identification of the infectious disease in the geographic area.

15. A system for identifying existence and spread of an infectious disease based on transaction data, comprising:
a transaction database configured to store a plurality of transaction data entries, wherein each transaction data entry includes data related to a payment transaction including at least a consumer identifier associated with a consumer involved in the related payment transaction and a transaction time and/or date;
a receiving device configured to receive disease data indicating a consumer associated with an infectious disease including at least a specific consumer identifier associated with the indicated consumer and an infection period of time;
a processing device configured to
identify a subset of transaction data entries stored in the transaction database where the included consumer identifier corresponds to the specific consumer identifier included in the received disease data and where the included transaction time and/or date is within the infection period of time included in the received disease data, and
identify at least one notification transaction data entry stored in the transaction database where the included transaction time and/or date and the transaction data corresponds to the transaction time and/or date and transaction data included in at least one transaction data entry in the subset; and
a transmitting device configured to transmit an infection notification, wherein the infection notification includes at least one of: the consumer identifier and a portion of the transaction data included in the identified at least one notification transaction data entry.

16. The system of claim 15, wherein the transaction data includes a geographic location.

17. The system of claim 15, wherein the infection period of time corresponds to a period of time prior to identification of the infectious disease as being associated with the indicated consumer.

18. The system of claim 15, wherein
the processing device is further configured to estimate a time of infection based on the correspondence between the transaction time and/or date and transaction data included in the at least one notification transaction data entry to the transaction time and/or date and transaction data included in the at least one transaction data entry in the subset, and
the infection notification further includes the estimated time of infection.

19. The system of claim 18, wherein the time of infection is associated with a consumer associated with the consumer identifier included in the identified at least one notification transaction data entry.

20. The system of claim 18, wherein
each transaction data entry further includes a geographic location, and
the time of infection is associated with a geographic area that includes the geographic location included in each of the at least one notification transaction data entry.
